(19) United States
(12) Patent Application Publication
(10) Pub. No.: US 2008/0032627 A1
(43) Pub. Date: Feb. 7, 2008

(54) BLUETOOTH WIRELESS COMMUNICATION SYSTEM FOR TRANSMITTING IMAGE DATA IN REAL TIME

(75) Inventor: Feng-Huan KANG, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 11/461,826

(22) Filed: Aug. 2, 2006

(51) Int. Cl. H04B 7/00

(52) U.S. Cl. 455/41.2

(57) ABSTRACT

A Bluetooth wireless communication system for transmitting image data in real time includes a host for receiving real-time image data and reproducing image, an image module for transforming image into electronic image data and sending electronic image data to the host, a first Bluetooth module physically connected to the host and enabling the host wirelessly communicated with other Bluetooth enabled devices, and a second Bluetooth module physically connected to the image module to enabling the host wirelessly communicated with other Bluetooth enabled devices. A control program which initializes and controls the image module is run in the second Bluetooth module.

### BACKGROUND OF THE INVENTION

1. Field of the Invention

The present invention relates to a wireless communication system, and more particularly, to a wireless communication system for transmitting image data in real time with Bluetooth wireless communication technology.

2. The Related Art

Nowadays, real-time image data transmitting technology is widely used, i.e., typically, a camera transmits real-time image data to a host (e.g., a computer, a PDA or a portable phone). Since the real-time image data is massive and should be delivered in time with small delay as possible, the real-time image data is better to be transmitted via physical cable connection.

Bluetooth is an emerging wireless communication standard for short-distance defined by a standardization group called the Bluetooth Special Interest Group (Bluetooth SIG), operating in the 2.4 GHz ISM band world-wide according to available existing specifications known in the art. It is convenient to establish a wireless connection between electronic devices using Bluetooth technology. Bluetooth SPP (Serial Port Profile) is a basic profile, it defines how to set-up virtual serial ports on two devices and connecting these with Bluetooth. Using this profile provides Bluetooth units with an emulation of a serial cable using RS232 control signaling (RS232 is a common interface standard for data communication equipment, it is the standard utilization on the serial port in the PC industry).

A conventional Bluetooth wireless communication system for transmitting image data in real time generally includes a Bluetooth enabled host and a Bluetooth enabled image module. Transmitting real-time image data via the Bluetooth SPP link is flexible and cost-effective, but each data packet will delay for several milliseconds (ms). Provided that the baudrate of the Bluetooth SPP link is 921.6 Kbps, then, each packet will delay for 20 ms. Commonly, the image module is configured without flash memory for cost down issues, therefore, the image module has to be initialized an extra control program. The control program is stored and run in the host and enables the host to initialize and control the image module by sending control commands thereto via Bluetooth wireless link. In another hand, each packet transmitted by Bluetooth SPP link under baudrate 921.6 Kbps delays for 20 ms. As a result, much time is wasted on delivering the control commands via Bluetooth wireless link. For example, at the startup process of the image module, the host initializes the image module by sending about 1400 control commands thereto, that will cost more than 3 minutes. As described above, the significant delay cannot satisfy the consumer's requirement. Therefore, a wireless communication system for transmitting image data in real time with less delay and higher efficiency is required.

### SUMMARY OF THE INVENTION

Accordingly, an objective of present invention is to provide a Bluetooth wireless communication system for transmitting image data in real time with less delay.

To achieve the above objective, the Bluetooth wireless communication system for transmitting image data in real time is provided which includes a host for receiving real-time image data and reproducing image, an image module for transforming image into digital image data and sending image data to the host, a first Bluetooth module physically connected to the host and enabling the host to wireless communication with other Bluetooth enabled devices, and a second Bluetooth module physically connected to the image module. A control program which initializes and controls the image module by sending control commands is stored and run in the second Bluetooth module. The control program for the image module is directly run in the second Bluetooth module which physically connects to the image module, Therefore, the control commands is not transmitted between the host and the image module via Bluetooth wireless link. As a result, it cuts the delay down and improves the transmitting efficiency of the real-time image data wireless communication system.

These and other features, objects and advantages of the present invention will be more fully apparent from the following detailed description set forth below when taken in conjunction with the accompanying drawings.

### BRIEF DESCRIPTION OF THE DRAWINGS

FIG. 1 is a schematic diagram showing a Bluetooth wireless communication system for transmitting image data in real time according to the present invention;

FIG. 2 is a flow diagram showing the transferring process of image data;

FIG. 3 is a block diagram showing the components of the second Bluetooth module; and

FIG. 4 is a flow diagram of the control program according to the present invention.

### DETAILED DESCRIPTION OF THE PREFERRED EMBODIMENT

The nature, objectives, and advantages of the invention will become more apparent to those skilled in the art after considering the following detailed description in connection with the accompanying drawings.

Although the invention is described with respect to specific embodiments, the principles of the invention as defined by the claims appended herein may be applied beyond the embodiments of the description described specifically herein. Moreover, certain details have been omitted to avoid obscuring the inventive aspects of the invention. The specific details not described in the present application are within the knowledge of a person of ordinary skill in the art, having the benefit of this disclosure.

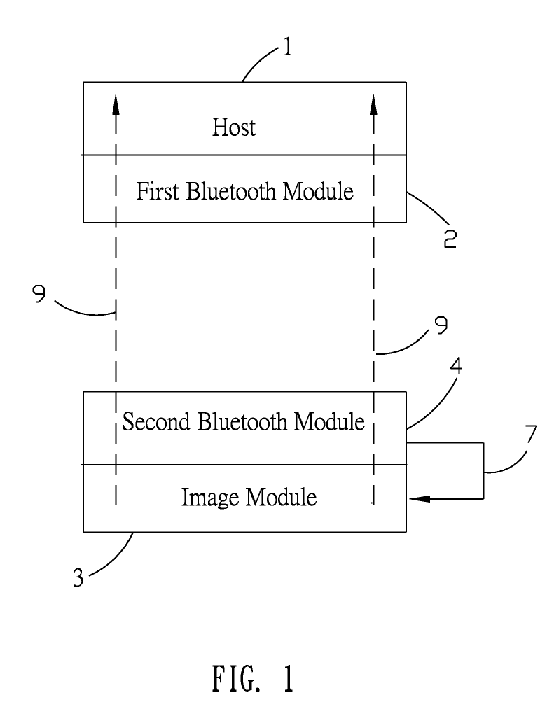

Referring to FIG. 1, a Bluetooth wireless communication system for transmitting image data 9 in real time according to the present invention includes a host 1, an image module 3, a first Bluetooth module 2 and a second Bluetooth module 4 making wireless communication between the host 1 and image module 3 for transmitting real-time image data 9.

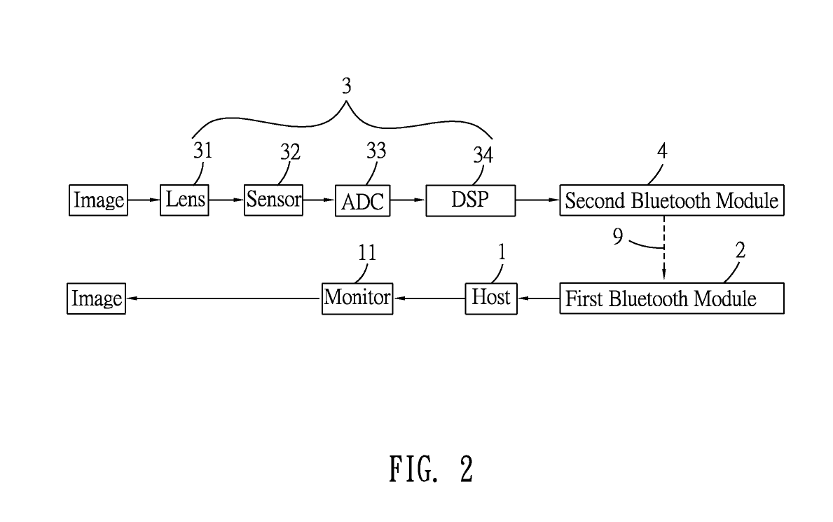

Please referring to FIG. 2, the host 1 is an electronic device (e.g. a computer, a PDA or a portable phone, etc.) used for receiving real-time image data 9 and therefore reproducing the image. The host is equipped with a monitor 11 for displaying the image.

The image module 3 is used for digitizing image into image data 9 and sending image data 9 to the host 1. Generally, the image module 3 includes a lens 31, an image sensor 32 (e.g. CCD, CMOS, etc.), an ADC (Analog-to-Digital Converter) 33 and a DSP (Digital Signal processor) 34.

The first Bluetooth module 2 is physically connected to the host 1 and enables the host 1 wirelessly communicated with other Bluetooth enabled devices. The host 1 is a computer and the first Bluetooth module 2 could be a Bluetooth Dongle. If the computer is running WINDOWS XP operating system with SP2 (Service Pack 2) or higher version, the Bluetooth driver program is a built-in function. Alternatively, the user can still install the driver program provided by the Bluetooth dongle supplier manually no matter the Bluetooth driver is implemented or not.

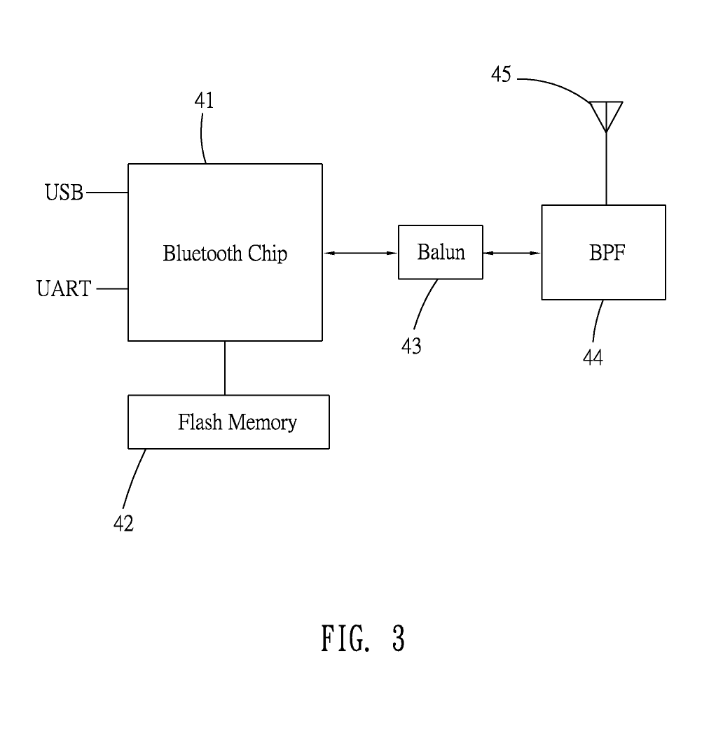

FIG. 3 shows the second Bluetooth module 4 which is physically connected to the image module 3 and enables the image module 3 wirelessly communicated to other Bluetooth enabled devices. The second Bluetooth module is based on a Bluetooth chip 41, preferably, the Bluetooth chip 41 is the CSR BC04-External chip, which provides a single-chip solution with RF and base-band on the same chip. Moreover, the second Bluetooth module 4 further includes a 8Mbit on-module flash memory 42 providing storage for Bluetooth software stack and application firmware, a Balun 43 for converting unbalance signal to balance signal, a BPF (Band Pass Filter) 44 for attenuating frequencies above or below the selected center frequency and boosting frequencies within the band, and a antenna 45 for radiating and receiving Bluetooth signals.

In the present embodiment, the first Bluetooth module 2 and the second Bluetooth module 4 establish a wireless communication link for transferring real-time image data 9 between the host 1 and image module 3 using SPP. The SPP sets up a virtual serial port relying on RFCOMM (Radio Frequency Communication, a serial cable emulation protocol) to replace the original physical connection.

FIG. 2 shows the transferring process of the image data 9. Firstly, the lens 31 focuses the light of the image on the image sensor 32. The image sensor 32 transforms the image into analog signal. Then, the analog signal of the image is converted to digital signal by the ADC 33 and further processed by DSP 34. Secondly, the processed image data 9 is sent to the host 1 via the Bluetooth wireless connection set up by cooperation of the second Bluetooth module and the first Bluetooth module. Finally, the host 1 reproduces image and displays image on its monitor 11.

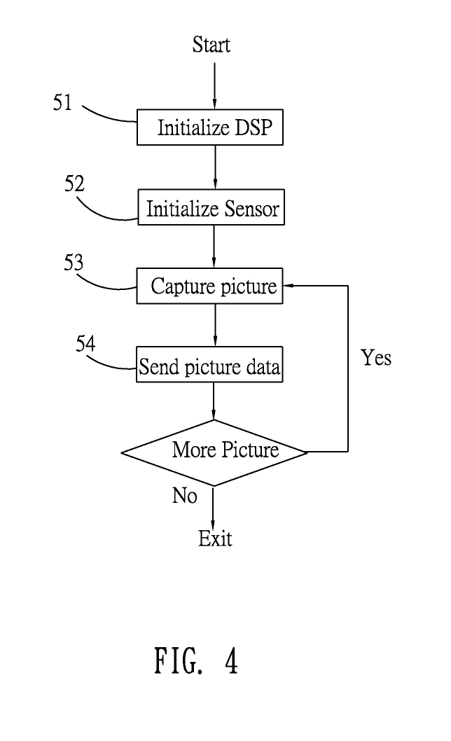

Now referring to FIG. 4, the image module 3 may be configured without flash memory for cost down issues. The image module 3 is controlled and initialized by a control program. The control program includes the following steps, in step 51, the control program firstly initializes the DSP chip 34 by setting parameters thereto. (e.g. resolution, saturation, masks, enable/disable global interrupt and lens shading compensation, etc.). Further in step 52, the sensor is activated by corresponding parameters. In steps 53 and 54, the image module 3 goes to capture picture and send picture data to the host over and over again.

Referring to FIG. 1 and FIG. 3, the control program described in the above is implemented into the second Bluetooth module 4. More specifically, the program code of the control program is embedded in the SPP software and enables the SPP software to initialize and control the image module 3. Then, the modified SPP software is burned in the 8Mbit flash memory 42 of the second Bluetooth module 4. Therefore, the second Bluetooth module 4 is able to initialize the image module 3 by setting large amount of parameters thereto as described above, and control the image module 3 to capture and transmit image data 9 by sending control commands 7 thereto.

The control program for the image module 3 is directly run in the second Bluetooth module 4 which physically connects to the image module 3. So that, the control commands 7 is not transmitted between the host 1 and the image module 3 via Bluetooth wireless link. As a result, it cuts the delay down and improves the transmitting efficiency of the real-time image data 9 wireless communication system.

Thus, specific embodiments and applications of Bluetooth wireless communication system for transmitting image data in real time have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. A Bluetooth wireless communication system for transmitting image data in real time comprising:
a host for receiving real-time image data;
an image module for capturing image and sending image data to said host;
a first Bluetooth module physically connected to said host;
a second Bluetooth module physically connected to said image module; and
a control program containing determined communication parameters for initializing and controlling said image module, said control program stored and run in said second Bluetooth module.

2. The Bluetooth wireless communication system for transmitting image data in real time as claimed in claim 1, wherein said first Bluetooth module and said second Bluetooth module establish a wireless communication link between said host and said image module using a serial port profile protocol.

3. The Bluetooth wireless communication system for transmitting image data in real time as claimed in claim 1, wherein said control program is embedded in a serial port profile software.

4. The Bluetooth wireless communication system for transmitting image data in real time as claimed in claim 1, wherein said second Bluetooth module comprises a flash memory, a Balun, a band pass filter and an antenna.

5. The Bluetooth wireless communication system for transmitting image data in real time as claimed in claim 4, wherein said control program is embedded in the Serial Port Profile software.

6. The Bluetooth wireless communication system for transmitting image data in real time as claimed in claim 5, wherein said serial port profile software is burned in said flash memory of said second Bluetooth module.

7. The Bluetooth wireless communication system for transmitting image data in real time as claimed in claim 1, wherein said image module comprises a lens 31, an image sensor, an analog-to-digital converter and a digital signal processor.

8. The Bluetooth wireless communication system for transmitting image data in real time as claimed in claim 6, wherein said control program includes the following steps:
a. initializing said digital signal processor by said parameters;
b. initializing said sensor by said parameters; and
c. controlling said image module to capture said image and send said image data to said host.
